(19) United States
(12) Patent Application Publication
(10) Pub. No.: US 2006/0002552 A1
(43) Pub. Date: Jan. 5, 2006

(54) Automatic and adaptive process and system for analyzing and scrambling digital video streams

(75) Inventors: Daniel LeComte, Paris (FR); Pierre Sarda, Asnieres-Sur-Seine (FR); Daniela Parayre-Mitzova, Paris (FR); Georges Sebastien, Paris (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: MEDIALIVE, a corporation of France, Paris (FR)

(21) Appl. No.: 11/187,161

(22) Filed: Jul. 22, 2005

Related U.S. Application Data
(63) Continuation of application No. PCT/FR04/50033, filed on Jan. 28, 2004.

(30) Foreign Application Priority Data
Jan. 28, 2003 (FR) 03/00923

(51) Int. Cl. H04N 7/167

(52) U.S. Cl. 380/217

(57) ABSTRACT

A process for automatically and adaptively scrambling digital video streams including analyzing structure and visual content of the digital video stream, and scrambling the digital video stream under regulation of an inference or decisional engine that selects a scrambling tool or tools to be applied to the digital video stream from a library of possible scrambling tools as a function of the analysis, of digital information relative to characteristics of a user, and from transport conditions of digital data in conformance with a base of predefined scrambling rules.

### RELATED APPLICATION

This is a continuation of International Application No. PCT/FR2004/050033, with an international filing date of Jan. 28, 2004 (WO 2004/071090 A2, published Aug. 19, 2004), which is based on French Patent Application No. 03/00923, filed Jan. 28, 2003.

### FIELD OF THE INVENTION

This invention relates to processing digital video streams, more particularly, this invention relates to a process and device that permits visual scrambling of digital video content.

### SUMMARY OF THE INVENTION

This invention relates to a process for automatically and adaptively scrambling digital video streams including analyzing structure and visual content of the digital video stream, and scrambling the digital video stream under regulation of an inference or decisional engine that selects a scrambling tool or tools to be applied to the digital video stream from a library of possible scrambling tools as a function of the analysis, of digital information relative to characteristics of a user, and from transport conditions of digital data in conformance with a base of predefined scrambling rules.

This invention also relates to a system for automatically and adaptively scrambling digital video streams including a module for analysis of structure and visual content of the digital video stream, a library module of scrambling tools, a module that scrambles the digital video stream and an inference or decisional engine module capable of making a synthesis of analysis information and available scrambling tools and generating scrambling instructions as a function of results of the analysis, available scrambling tools, user profile and the transport conditions in conformity with a rule base that it contains.

### BRIEF DESCRIPTION OF THE DRAWINGS

FIG. 1 is a block diagram of a system in accordance with aspects of the invention.

FIG. 2 is a block diagram of other aspects of the invention.

### DETAILED DESCRIPTION

The invention includes a device that transmits in a secure manner a set of high-quality visual films to a TV screen and/or for being recorded on the hard disk or any other backup device of a box connecting the telecommunication network to a display screen such as an audiovisual projector, a TV screen or a PC monitor while preserving the audiovisual quality, yet avoiding fraudulent use such as the possibility of making pirated copies of films or of audiovisual programs recorded on the hard disk or any other backup device of the decoder box.

The invention also includes a process for scrambling digital video streams that relates to distributing digital video sequences in accordance with a nominal stream format constituted of a succession of frames, each of which comprises at least one digital block regrouping a certain number of elements corresponding to simple video elements (e.g., coefficients) digitally coded according to a mode defined within the concerned stream and used by all video decoders capable of deciding it to be able to display it correctly.

The distribution mode of the digital video streams comprises:
a preparatory stage comprising modifying at least one of the elements of the digital video stream,
a transmission stage
   of a main stream modified in conformity with a nominal format constituted of planes containing blocks modified in the course of the preparatory stage, and
   a separate path of the modified mainstream of complementary digital information permitting reconstitution of the original stream on recipient equipment as a function of the main stream and the complementary information. The complementary information is defined as a set constituted of data (e.g., elements describing the original digital stream or extracts of the original stream) and functions (e.g., the substitution or permutetion/swapping function. A function is defined as containing at least one instruction that puts the data and the operators in a relationship. The complementary information describes the operations to be carried out to recover the original stream from the modified stream.

Reconstitution of the original stream is carried out on the recipient equipment from the modified main stream already present on the recipient equipment and from the complementary information transmitted in real time at the moment of the display comprising data and functions executed with the aid of digital routines (set of instructions).

The invention defines the notion of “stream” as a structured binary sequence constituted of simple and ordered elements representing data in coded form and responding to a given audiovisual standard or norm.

The fact of having removed part of the original data of the original stream during generation of the modified main stream does not permit restitution of the original stream from only the data of the modified main stream. The modified main stream is thus called the “secured stream”. “Secured distribution” is a distribution of secured streams.

The term “scrambling” denotes the modification of a digital video stream by appropriate methods in such a manner that the stream remains in conformity with the standard or the norm with which it was generated while rendering it displayable by a reader (or display device or player), but altered from the viewpoint of human visual perception.

The term “descrambling” denotes the process of restitution by appropriate methods of the original stream, which video stream that is restituted after the descrambling is substantially identical, that is, without loss, to the original video stream.

The notion of “scalability” is defined from the English word “scalability” that characterizes an encoder capable of encoding, or a decoder capable of decoding an ordered set of binary streams in such a manner as to produce or reconstitute a multilayer sequence.

The notion of “granular scalability” is defined from the English term “granular scalability.” Granularity is defined as the quantity of variable information capable of being transmitted per layer of a process characterized by any scalability, which process is then also granular. The granular scalability translates into the property of carrying out an analysis and a scrambling at different degrees (or layers) of complexity.

Many scrambling systems have an immediate effect—either the original stream is totally scrambled or the original screen is not scrambled at all. Moreover, in the majority of protection systems the different video sequences are scrambled with the same algorithm and regulating parameters. Numerous protections used do not change the scrambling of a video stream as a function of its content, its structure and of the conditions of transmission.

An automatic and adaptive scrambling of the video stream is applied as a function of its structure, its contents, of the transport conditions of the distribution system and of the user profile (that is characterized by the digital information), which is performed to realize a reliable protection from the viewpoint of the deterioration of the original stream and resistance to pirating at a minimal cost while assuring in the end the quality of service required by the spectator or the client as well as a service personalized for each client. The scrambling stage is preceded by an analysis stage with the aid of appropriate tools and, as a function of the results of the analysis, the scrambling tools are optimized by an inference engine/mechanism internal to the process.

The term “profile” of the user denotes a digital file comprising descriptors and information specific to the user, e.g., cultural preferences and cultural and social characteristics, habits of use such as the frequency of using video means, average time of displaying a scrambled film, frequency of displaying a scrambled sequence, or any other behavioral characteristic regarding use of films and video sequences. The profile is formalized by a digital file or a digital table that can be used by a computer.

In its most general meaning, the process for automatic and adaptive scrambling of a digital video stream comprises:
analyzing the structure and visual content of the digital video stream with analytical tools,
scrambling the digital video stream, and
selecting scrambling tools to be applied to the digital video stream with an inference or decisional engine from a library of possible scrambling tools as a function of the analytical stage, of digital information relative to the characteristics of the user for which the scrambled digital video stream resulting from the process is intended, and from the transport conditions of the digital data resulting from the process in conformity with a base of predefined scrambling rules.

The process is advantageously self-adaptive and self-decisional in accordance with the inference engine selected.

The decision concerning scrambling to be carried out on the video stream can be made by one skilled in the art.

The process can have an inference engine that has the ability to teach itself from rules provided by one skilled in the art and by actions.

The analytical stage may have several levels of scalability. The scrambling tools may have several levels of scalability. The scrambling process advantageously has several levels of granular scalability.

The scrambling process advantageously has the ability to make scrambling decisions in such a manner as to respect the constraints of the transmission speed/output of the telecommunication networks via which the complementary information is transmitted to the user for which the scrambled stream is intended.

The scrambling process advantageously has the ability to make scrambling decisions from an analysis of the video stream in real time. The scrambling process advantageously also has the ability to adapt the quantity of complementary information in real time as a function of the immediate resources in the output/throughput and of the transport conditions of the telecommunication networks. The scrambling process advantageously has the ability to carry out the analysis and scrambling prior to transmission to the user.

The inference engine advantageously has the ability to make scrambling decisions in such a manner as to respect the constraints, features and performances of the decoder box of the user for which the scrambled stream is intended. The inference engine advantageously has the ability to make scrambling decisions as a function of scrambling decisions which it previously made.

The scrambling tools used to process a part of the stream are advantageously parameterized by original characteristics of the previously scrambled parts, which characteristics are stored in the complementary information.

The random values used by the scrambling tools are advantageously generated by a generator of random variables and are passed in parameters to these scrambling tools.

The scrambling process advantageously comprises an inference engine that makes decisions concerning scrambling to be performed on the video stream in an automatic and auto-adaptive manner as a function of the user profile. The scrambling process advantageously comprises an inference engine that makes decisions concerning scrambling to be performed on the video stream in an automatic and auto-adaptive manner as a function of the transport conditions.

The scrambling process is advantageously applied to structured digital video streams stemming from a digital video standard or norm.

The invention also relates to a system for carrying out the process that comprises a module for analyzing the structure and visual content of the digital video stream, a module constituted of a library of scrambling tools, a module that scrambles the digital video stream and an inference or decisional engine module capable of making the synthesis of analysis information and available scrambling tools and generating scrambling instructions as a function of the results of the analysis, the available scrambling tools, the user profile and the transport conditions in conformity with the rule base that it contains.

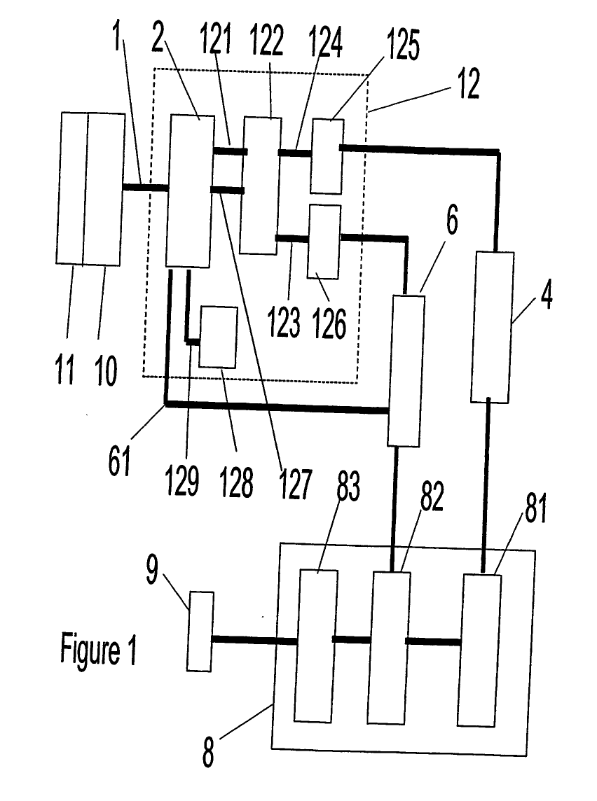

Turning now to the drawings, FIG. 1 shows a client-server system comprising a particular embodiment of the scrambling system of digital video streams in conformity with aspects of the invention.

The video stream of the MPEG-2 type that is to be secured 1 is passed to analysis system 2 that generates instructions 127 for the scrambling, then to scrambling system 122 that generates a modified mainstream 124 and complementary information 123 at the output.

Original stream 1 can be directly in digital form 10 or in analog form 11. In this latter instance, analog stream of 11 is converted by a coder (not shown) to a digital format 10. In the rest of the texts, 1 denotes the input digital video stream and 121 the original digital stream at the output of analysis module 2. A first stream 124 with a format identical to the input digital stream 1, aside from the fact that certain coefficients values and/or vectors have been modified, is placed in output buffer memory 125. The complementary information 123 of any format contains the references of the parts of the video samples that were modified and placed in buffer 126. Analysis system 2 decides which adaptive scrambling to apply and which parameters of the stream to modify as a function of the characteristics of input stream 1 and digital information relative to the characteristics of the client 129 coming from client database 128. Modified stream 120 is then transmitted via a network 4 such as microwave, cable, satellite and the like, for example, to the decoder box (set top box) of client 8 and, more precisely, into its memory 81 of the RAM, ROM, hard disk type. When the addressee 8 makes a request to display a video sequence present in its memory 81, there are two possibilities:
Either addressee 8 does not have the rights necessary to display the video sequence. In this instance, stream 125 generated by scrambling system 122 present in its memory 81 is passed to synthesis system 82, that does not modify it and transmits it identically to a classic video reader 83 and its content, heavily degraded visually, is displayed by reader 83 on screen 9; or
Addressee 8 has the rights for viewing the video sequence. In this instance, the synthesis system makes a display request to server 12 containing the information necessary 126 for recovery of the original video sequence 1. Server 12 transmits the appropriate complementary information 126 that permits reconstitution of the video sequence in such a manner that that client 8 can display and/or store the video sequence as a function of the transport conditions 61 over connection 6 via transmission networks of the analog or digital telephone line, DSL (digital subscriber line), BLR (local radio loop), DAB (digital audio broadcasting) type or via mobile digital telecommunications (GSM, BPRS, UMTS). Synthesis system 82 then proceeds to descrambling the video by reconstructing the original stream by combining the modified main stream 125 and the complementary information 126. The obtained video stream at the output of synthesis system 82 is then transmitted to classic video reader 83 and the original video film is displayed on screen 9.

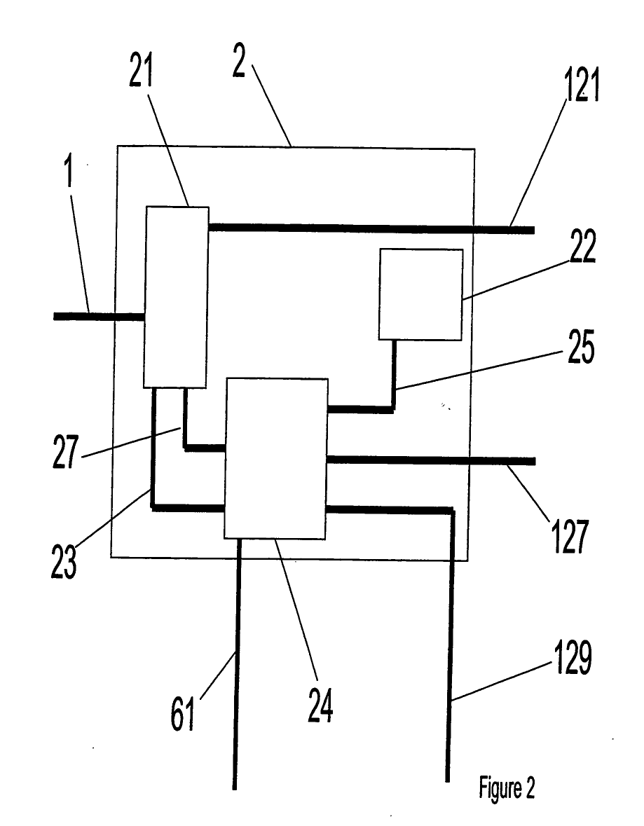

FIG. 2 shows a preferred embodiment of the automatic and adaptive analysis system.

In order to optimize the application of the technology described for the protection the video stream, it is necessary to apply the most appropriate scrambling as a function of the content analyzed. To this end, analysis module 2 analyzes digital video stream 1 to extract certain information 23 from it and to deduce from it the best-adapted scrambling tools and associated parameters 127. The system is thus adaptive in that it adapts to the content into the structure of the stream that it analyzes, and decisional in that it decides itself the scrambling to be performed.

Analysis system 2 comprises three parts:
analysis module 21 containing the analysis tools,
a library of scrambling tools 22, and
inference engine 24 containing the rules defined by one skilled in the art that permit selection of the scrambling tools contained in tool library 22 to be applied to digital video stream 121 at the output of analysis module 2. The choice of scrambling tools 127 is made as a function of the results of analytical stage 23, the digital information relative to the rights of user 129 coming from client database 128 and transport conditions 61 of complementary information 123 on connection 6. The scrambling tools to be applied 127 are selected by inference engine 24 from a library of tools 22 via connection 25. This selection 127 is transmitted to scrambling module 122. Inference engine 24 can request a supplementary analysis by sending a request to end 27 to analysis module 21.

The system is characterized by a granular scalability concerning the complexity of the analysis of the digital stream. A more or less extensive and complex analysis of the digital video stream corresponds to each level or layer of scalability. The study of characteristics proper to a given structural level of the stream: At the level of the GOP (“Groups Of Pictures” or Groups of Planes), picture or plane, slice, macroblock, block are considered as levels of scalability of the analysis of the digital video stream. For example, in the case of the scalability level concerning the pictures, only the header information of pictures is studied.

Likewise, the system is characterized by a granular scalability concerning the complexity of the scrambling tools to be used. The latter is characterized by the possibility of modifying more or less, one or several elements of the same type or of different types in accordance with the desired level of scalability. For example, in the case of scrambling tools for the substitution of DC coefficients, the system substitutes one, several or all the DC coefficients by selected macroblock. The inference engine itself also has properties of granular scalability in that it uses the scalability properties of the tools for analysis and scrambling. For example, the inference engine selects a more or less extensive level of scalability as concerns the analytical tools as a function of the processing time that it has for carrying out the scrambling (real time or not). Likewise, the inference motor selects a more or less extensive level of scalability as concerns the scrambling tools as a function of the transport conditions of the complementary information.

Inference engine 24 preferably selects a more or less extensive level of scalability of the tools in scrambling tool library 22 as a function of the technical characteristics of client decoder box 8 for which scrambled stream 125 is intended that are recovered from client database 128. In fact, the more expensive the level of scalability selected, the more important the hardware and software resources necessary for descrambling the protected stream 125 are. For example, a scrambling tool concerning the movement vectors will not be used if the client decoder does not have sufficient calculating resources and, in this instance, a modification of the header information of pictures I is preferred.

Consequently, the system has the advantage of being able to limit the output and size of the complementary information. The cost of transmitting the complementary information is thus mastered by one skilled in the art who manages the scrambling system.

One aspect includes a scrambling system that is self-adaptive in that it is capable of making decisions concerning the scrambling of the stream automatically and independently of an expert in the art. Another aspect is a manual system in which one skilled in the art selects the scrambling tools to be used.

Another aspect is a system that is at the same time manual in that one skilled in the art selects the scrambling tools and the analytical level of scalability to be used, but also automatic in that the system, starting from rules previously defined in the inference engine, automatically makes adaptations as a function of the content to optimize the parameters. The system works out new rules and thus completes the inference engine as a function of the actions of one skilled in the art. For example, if the same decision is made several times (at least three times) for several different video streams to apply a scalability level of tools of a more complex scrambling, after the first thirty seconds of video, the system then automatically establishes a new rule comprising in applying a more complex level of scalability of the scrambling tools after the first thirty seconds of each stream. This rule permits, e.g., allowing thirty seconds of slightly scrambled video at the beginning of each stream.

Analytical tools 21 supply information about the structure of binary stream 1 and about its content. A digital video stream is generally constituted of sequences of pictures (or planes or frames grouped in groups of pictures “Groups Of Pictures” (GOPs) for MPEG-2, for example. For MPEG-4 the planes or the VOPs (Video Object Plane) are grouped in “Groups Of Videos” (GOVs). A picture can be of the I type (Intra), P type (Predicted), B (bidirectional). A plane S is a plane containing a static object that is a fixed picture describing the background of the picture or a plane coded using a prediction based on the global movement compensation (GMC) starting from a prior reference plane. The I pictures are reference pictures that are entirely coded and are therefore of an elevated size and do not contain information about the movement. The P planes are planes predicted from preceding planes, whether I and/or P, by vectors of movement in one direction only called forward. The B planes are called bidirectional and are connected to the I and/or P planes preceding them or following them by vectors of movement in both directions of time (forward and backward). The movement factors represent bidimensional vectors used for compensation of movements that bring about the difference of coordinates between a part of the current picture and a part of the reference picture. An image can be organized by slices, e.g., as in MPEG-2. A picture or a frame is constituted of macroblocks constituted themselves of blocks containing elements describing the content of the video stream, e.g., the DC coefficients stemming from a frequency transformation and relative to the fundamental, that is to say, to the average value of the coefficients of a block or the AC coefficients relative to the most elevated frequencies. The AC coefficients are coded in “run” and “level”, of which the “runs” are the number of zeros between two non-null AC coefficients and the “levels” are the value of the non-null AC coefficients. The blocks also contain information about the movement vectors.

Analytical tools 21 are used to extract information 23 about the structure and content of the pictures, VOPs, slices, macroblocks and blocks to adapt and optimize their scrambling. Several different complexities in the use of the tool set are worked out according to whether the application is real time (e.g., when the scrambling is applied to a video stream broadcast in real time) or whether the content is completely scrambled before transmission, thus leaving the time necessary for every form of analysis (a more or less extensive analysis of the pictures/VOPs to extract the maximum amount of information from them). In real time, the analysis of the correlations between pictures/VOPs can only be made for some successive pictures/VOPs, thereby reducing the study parameters, whereas with an extensive analysis without real time constraints, every latitude for the number of successive pictures/VOPs to be analyzed is possible.

In the case of the scrambling and transmission of video stream 1 in real time, analytical system 2 must decide in real time the scrambling tools to be applied 127. Relatively “simple” analytical and scrambling tools 127 are then used in a quantity adapted to the constraints of real time.

In the case of a scrambling without real-time constraints, analytical system 2 makes an extensive analysis for using the most pertinent information 23 to make a decision about scrambling tools 127. The decision about the type of scrambling 127 can be generated automatically and in an adaptive manner by inference engine 24 or a manual maneuver.

In one aspect, a decision is made as to which scrambling is to be performed by viewing the scrambled stream on a console and adapting its scrambling parameters as a function of the degradation and the results relied on.

The invention will be better understood from a reading of a particular exemplary embodiment of analytical module 2 applied to streams of the MPEG-2 type.

Analytical tool module 21 comprises the tools for carrying out the following analyses:
An analysis of the AC (run, level) and DC coefficients to determine the content of the scenes and the pertinent parts to be scrambled, comprising comparing their values (differential parts of the DC coefficients, level of the AC coefficients) at predefined thresholds. It is thus possible to detect homogenous zones with this analysis, zones containing many details or even contours.
An analysis of the size of the macroblocks by the number of AC coefficients that they contain.
An analysis of the values of the quantification steps used during coding of the AC and/or DC coefficients and transmitted within the digital video stream to detect the contours.
A counting of the relative number of intra blocks in the P and B pictures to detect a change of scene.
Use of the size and value of the movement vectors and their distribution in each picture in a GOP for finding correlations of movement and delimiting different objects characterized by their uniformity of displacement.

This analytical module is associated with a library of scrambling tools 22 containing in a non-exhaustive manner:
A tool comprising substituting an AC coefficient by a random value with the same size.
A tool comprising substituting an AC coefficient by its opposite.
A tool comprising substituting an AC coefficient by a random value with a different size.
A tool comprising substituting a DC coefficient by a random value of the same size.
A tool comprising substituting a DC coefficient by its opposite.
A tool comprising substituting a DC coefficient by a random value with a different size.
A tool comprising substituting a movement vector by a random value.

These random values used by these scrambling tools are advantageously generated by a generator of random variables and are passed in parameters to the scrambling tools.

The third module is the decisional inference engine 24. The choice of the combinations of transformations to be carried out 127 (number, type and coefficients to be substituted, number of pictures to which the transformations apply) requires a manual or automatic parameterization and this is the role of inference engine 24. The decision rules of the inference engine that permit determination of the scrambling tools to be applied can vary as the processing of the original video stream 1 does.

In one exemplary aspect, the decisions of inference engine 24 to apply scrambling tools to a portion of the stream are a function of the processing decisions made for the preceding portions of the stream to be scrambled. For example, if a picture I of an MPEG-2 stream was entirely scrambled using a deep level of scalability, the degradation effect is propagated strongly onto the following frames and inference engine 24 uses tools that degrade the following images B and P. In the instance in which the applied tools slightly degrade an image I (inversion of the sign of the DC coefficients of the picture, e.g.) or have a shallow scalability level, inference engine 24 will decide to use scrambling tools that heavily degrade the following B and P pictures.

Inference engine (24) takes into account the rights of the user 129 coming from client database 128 and constraints of the network such as the online throughput/transmission rate 61 or the maximum volume of information to be transmitted 61. For example, it can be desired to modify all the DC coefficients of all the I pictures in such a manner that the film is not acceptable as regards human visual perception. Nevertheless, the more significant the number of modifications, the more significant the size of the complementary information. The solution therefore comprises modifying the DC coefficients with the aid of a general algorithm that does not necessitate storing the original values in the complementary information (e.g., an inversion of sign). Thus, it is sufficient during descrambling to re-invert the sign of the DC coefficients to obtain the original value. The disadvantage of this method is that the scrambling obtained is not very difficult to spot for an ill-intentioned user, who can then readily re-invert the sign to reconstitute the original stream.

One or several other scrambling methods are carried out in parallel to render the process difficult to detect: For example, modify several AC coefficients by replacing them with random values. The fact of not modifying them systematically and removing the original value of the stream renders the obtained scrambling difficult to detect and thus difficult to break. Moreover, the picture remains non-viewable due to the systematic modifications of the DC coefficients. The AC coefficients to be modified are selected with an algorithm to detect interesting elements in such a manner that if a pirate were to succeed in defeating the protection connected to the DC coefficients, the pirate would have a video whose most interesting elements (actors, movements) would still be scrambled on account of the modification of the AC coefficients. Only the AC coefficients greater than a previously defined threshold are then modified. These values have, in fact, the tendency to be elevated for the contours of the video objects.

Likewise, to render the modifications even more difficult to detect and therefore to render the scrambled video stream 125 more difficult to correct, inference engine 24 decides to apply scrambling tools parameterized by the characteristics of the original substituted elements. For example, a first DC coefficient is substituted by a random value of a different size and its true value, its size as well as its original position are stored in complementary information 126. The following n DC coefficients are then modified by the addition (or any other invertible binary operation taking two parameters at the input such as an exclusive OR, for example) of a binary word specific to the original characteristics of the substituted DC coefficient. To be able to descramble these n DC coefficients, the client decoder box 8 makes use of the content of complementary information 126 relative to the first DC coefficient to process the following n DC coefficients in accordance with the inverse operation.

Another exemplary aspect is one pertaining to streams of the MPEG-4 type of which the analytical module 21 contains the following tools:
Analysis of the AC (run, level) and DC coefficients to determine the content of the pertinent scenes and parts to be scrambled comprising comparing their values (differential part of the DC coefficients, level of the AC coefficients) with predefined thresholds. It is thus possible to detect homogeneous zones, zones containing many details or even contours with this analysis.
Analysis of the size of the macroblocks by the number of AC coefficients that they contain.
Analysis of the values of the quantification steps used during coding of the AC and/or DC coefficients and transmitted within the digital video stream to detect the contours.
Counting the relative number of intra blocks in the P and B pictures to detect a change of scene.
Use of the size and the value of the movement vectors and their distribution in each picture within a GOP to find correlations of movements and delimit different objects characterized by their uniformity of displacement.
Studies of certain values (e.g., the movement vectors) for several successive VOPs to find the ideal number of successive VOPs to transform.

This analytical module is associated with a library of scrambling tools 22 containing in a non-exhaustive manner:
A tool comprising substituting an AC coefficient by a random value with the same size.
A tool comprising substituting an AC coefficient by its opposite.
A tool comprising substituting an AC coefficient by a random value with a different size.
A tool comprising substituting a DC coefficient by a random value of the same size.
A tool comprising substituting a DC coefficient by its opposite.
A tool comprising substituting a DC coefficient by a random value with a different size.
A tool comprising substituting a movement vector by a random value.

These random values used by these scrambling tools are advantageously generated by a generator of random variables and passed in parameters to the scrambling tools.

The third module, inference engine 24 uses the time dependencies between VOP that are the base of the compression of the MPEG type and that permit only a part of the elements present in the stream to be transformed while ensuring good protection of the objects processed in this manner, which processing propagates on account of these dependencies. Furthermore, processing only a part of the coefficients of a VOP is perfectly coherent and efficacious since the adjacent coefficients in one and the same VOP are correlated.

It is thus apparent that only a part of the information can be transformed as a function of the content of the video stream while ensuring that the final protection is good. It is possible to generalize the transformations as a function of the result counted on in the form of a series of parameters to be applied: Processed VOPs, frequency of processing successive VOPs of the same type, frequency of macroblocks processed in each VOP and, for these macroblocks, the number of blocks processed and the type of solution applied to the AC or DC coefficients and to the values of differential movement vectors.

Certain combinations of scrambling tools 127 are more advantageous to implement than others as a function of analysis results 23. Thus, considering their very significant role in the stream, planes I are scrambled with priority. The inference engine chooses to scramble them more or less strongly as a function of the spacing between the successive I planes and the coding quality of the P planes following in the stream. If two I planes are separated by a large number of P and/or B planes, then everything depends on the quality of the P planes: If the following P planes contain few macroblocks coded in Intra, the inference engine will select scrambling tools that strongly degrade the visual rendering (substitution of DC coefficients by random values) of the I plane preceding them. Otherwise, the Intra blocks of the following P planes will reconstitute the visual rendering, in which case the inference engine favors application of scrambling tools on the P planes.

As concerns the P planes, two pieces of information are particularly important: The number of macroblocks coded in Intra in the VOP, because these macroblocks contain important information for reconstructing the stream P: The more of them there are, the better the quality of the stream. In fact, they contain the information that can not be deduced from the movement of the video object that is moving, but for which it is not known which other object is going to replace it. For example, in a scene representing opening a door, it can not be guessed what is behind the door: It is necessary to replace the data of reference plane I or of the previous P planes to render this information in conformity with the requirements of the moment. The second piece of information is that of the movement contained in the differential movement vectors. One skilled in the art, knowing these properties of digital video streams, defines rules for the inference engine that permit optimization of the visual degradation generated by the scrambling as a function of the quantity of information substituted. Thus, the more important the information is for the visual rendering of the video stream, the more the inference engine must scramble it.

In a particular exemplary aspect, inference engine 24 knows the number of video streams already visualized by client 8 on account of the client data 129 coming from client database 128. Inference engine 24 decides to allow, in accordance with the number of video streams already visualized, a non-scrambled range with a greater or lesser length at the beginning of progressively scrambled stream 121.

The exemplary embodiments of the system for digital streams of the MPEG-2 and MPEG-4 types described above can be transposed to any structured digital stream defined by another norm or another digital audiovisual standard.

1. A process for automatically and adaptively scrambling digital video streams comprising:
analyzing structure and visual content of the digital video stream, and
scrambling the digital video stream under regulation of an inference or decisional engine that selects a scrambling tool or tools to be applied to the digital video stream from a library of possible scrambling tools as a function of the analysis, of digital information relative to characteristics of a user, and from transport conditions of digital data in conformance with a base of predefined scrambling rules.

2. The process according to claim 1, wherein the inference engine is self-adaptive and self-decisional.

3. The process according to claim 2, wherein the inference engine has the ability to teach itself and determine new decision rules from rules previously established.

4. The process according to claim 1, wherein the analysis has several levels of scalability.

5. The process according to claim 1, wherein the scrambling tools have several levels of scalability.

6. The process according to claim 1, wherein the scrambling has several levels of granular scalability.

7. The process according to claim 1, wherein the inference engine has the ability to make scrambling decisions in such a manner as to respect constraints of telecommunication networks via which complementary information is transmitted to the user for which the scrambled stream is intended.

8. The process according to claim 1, having the ability to make scrambling decisions from an analysis of the video stream in real time.

9. The process according to claim 8, having the ability to adapt a quantity of complementary information in real time as a function of immediate resources in an output/throughput and transport conditions of the telecommunication networks.

10. The process according to claim 1, having the ability to carry out the analysis and scrambling prior to transmission to the user.

11. The process according to claim 1, wherein the inference engine has the ability to make scrambling decisions in such a manner as to respect constraints, features and performances of a decoder box of the user for which the scrambled stream is intended.

12. The process according to claim 1, wherein the inference engine has the ability to make scrambling decisions as a function of scrambling decisions which it previously made.

13. The process according to claim 1, wherein scrambling tools used to process a part of the stream are parameterized by original characteristics of previously scrambled parts, which characteristics are stored in complementary information.

14. The process according to claim 1, wherein random values used by scrambling tools are generated by a generator of random variables and are passed in parameters to these scrambling tools.

15. The process according to claim 1, wherein a decision concerning scrambling to be performed on the video stream is automatic and auto-adaptive as a function of a user profile.

16. The process according to claim 1, wherein a decision concerning scrambling to be performed on the video stream is automatic and auto-adaptive as a function of transport conditions.

17. The process according to claim 1, applied to structured digital video streams stemming from a digital video norm or standard.

18. A system for automatically and adaptively scrambling digital video streams comprising a module for analysis of structure and visual content of the digital video stream, a library module of scrambling tools, a module that scrambles the digital video stream and an inference or decisional engine module capable of making a synthesis of analysis information and available scrambling tools and generating scrambling instructions as a function of results of the analysis, available scrambling tools, user profile and the transport conditions in conformity with a rule base that it contains.
